(19) United States
(12) Patent Application Publication
(10) Pub. No.: US 2008/0024286 A1
(43) Pub. Date: Jan. 31, 2008

(54) Method for Recognizing an Abnormality in the Chassis of a Motor Vehicle

(75) Inventor: Karl Perras, Muehlacker (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: DAIMLERCHRYSLER AG, STUTTGART (DE)

(21) Appl. No.: 10/584,123

(22) PCT Filed: Dec. 10, 2004
(86) PCT No.: PCT/EP04/14080

§ 371 Date: Apr. 19, 2007

(30) Foreign Application Priority Data
Dec. 23, 2003 (DE) 103 60 723.4

(51) Int. Cl. B60C 23/02

(52) U.S. Cl. 340/442; 340/438

(57) ABSTRACT

In a method for recognizing a loss of pressure in a tire of a motor vehicle, an anomaly in the chassis, such as a loss of tire pressure, is recognized by comparing an indicative value indicative of the chassis anomaly or the tire pressure with a comparative value. An instantaneous indicative value that is indicative of the chassis anomaly or the tire pressure is determined. A comparative value is stored in a learning step when a learning threshold is reached, and previously determined indicative values are used for determining the comparative value to be stored. An anomaly in the chassis or a loss of pressure in a tire is recognized by comparing the instantaneous indicative value with the comparative value. An intermediate value or determined indicative value is stored if the predefinable learning threshold has not been reached.

### BACKGROUND AND SUMMARY OF THE INVENTION

This invention relates to a method for recognizing an anomaly in the chassis of a motor vehicle, and in particular, for recognizing a loss of pressure in a tire of a motor vehicle. In this method, an anomaly in the chassis is recognized by comparing a value that is indicative of a chassis parameter with a comparative value. In particular, an incorrect tire pressure is recognized by comparing a value that is indicative of tire pressure with a comparative value.

A method for recognizing an anomaly in the chassis of a motor vehicle is known from German document DE 197 21 480 A1. This document concerns a method for recognizing loss of pressure in motor vehicle tires based on evaluation of wheel speed information. A value that is indicative of pressure is generated from signals representing the wheel speeds of the vehicle wheels. The tire pressure is monitored, and a loss of pressure is recognized by comparing the pressure-indicative value with a comparative value. A conclusion is made that pressure loss has occurred when the pressure-indicative value is less than the comparative value.

A method for recognizing loss of pressure in motor vehicle tires is known from international publication WO 03/086789. In this method, an average value of a wheel speed ratio is compared to a learned value. To enable recognition of pressure loss, first the learned value must be determined. For this purpose the normal state is learned after the algorithm is restarted. When sufficient rotational speed values have been assessed for a statistical evaluation, the learning phase is ended and the learned value is generated. In the subsequent comparative phase, an average is formed from determined values of the wheel speed ratio. After sufficient suitable values have been taken into consideration, the averaged parameter is compared to the learned value to recognize a loss of pressure.

It is also known from international publication WO 03/086783 to generate multiple learned values separately for predefined speed ranges associated with these learned values.

Proceeding from this prior art, the object of the invention is to provide a method for recognizing a chassis anomaly, by which a deviation of a value for a chassis parameter from a standard value is recognized more quickly and reliably. The object in particular is to provide a method for recognizing loss of pressure by which a loss of pressure in a motor vehicle tire can be recognized more quickly and reliably.

Within the scope of the method according to the invention for recognizing a chassis anomaly, an instantaneous value that is indicative of a chassis parameter is determined by using a parameter that is indicative of the driving dynamics. Examples of chassis anomalies to be recognized include, among others, loss of tire pressure, tire sidewall damage, rupture of the tire carcass, separation of tire tread blocks, tire or wheel imbalance, wheel rim deformation, wheel rim rupture, wheel bearing damage, axle damage, in particular axle bearing damage, shock absorber damage, a detached fastening means, in particular a detached wheel lug bolt, or detachment of a part, in particular a wheel sensor. Examples of parameters that are indicative of the driving dynamics, i.e., values indicative of the chassis condition, include, among others, the vehicle yaw rate, transverse or longitudinal acceleration of the vehicle, wheel vibrations, axle vibrations, vehicle level, or spring excursion.

In carrying out the method, a comparative value is determined and stored in a learning step. The comparative value is determined and stored if a predefinable learning threshold is reached. Previously determined values that are indicative of the chassis are used to determine the comparative value to be stored. A chassis anomaly is recognized by comparing the instantaneous chassis-indicative value with the comparative value. An intermediate value or a chassis-indicative value is stored if the predefinable learning threshold for storing the comparative value has not been reached, and a storage triggering condition is also met.

The inventive approach to the object of the invention statistically accelerates learning of the comparative value. The learning phase for the algorithm is abbreviated by storing the intermediate value or the determined indicative values for the chassis. Partial advances in determining the comparative value are retained, and are not lost. Based on these partial advances, the learning phase, for example after the motor vehicle is restarted, can be continued, even if the method has been interrupted or terminated in the meantime. As a result of the learning phase being abbreviated in this manner, the recognition of a chassis anomaly is made more reliable, since a comparative value is already present at an earlier time, or a comparative value already present at an earlier time can be replaced by a new, better comparative value.

In a preferred embodiment of the method according to the invention, in the recognition of pressure loss in a motor vehicle tire, an instantaneous pressure-indicative value that is indicative of the tire pressure is determined by using wheel speed information. A comparative value is also determined and stored in a learning step. The comparative value is determined and stored if a predefinable learning threshold is reached. Previously determined pressure-indicative values are used to determine the comparative value to be stored. A loss of pressure in a tire is recognized by comparing the instantaneous pressure-indicative value with the comparative value. An intermediate value or a pressure-indicative value is stored if, first, the predefinable learning threshold for storing the comparative value has not been reached, and, second, a predefinable storage triggering condition is met. The recognition of pressure loss is made more reliable as a result of the learning phase being abbreviated by storing the intermediate value.

In one embodiment, the learning threshold is specified by requiring a minimum number of determined values indicative of the driving dynamics, in particular, determined values indicative of pressure, to be present. Only when this minimum number of values indicative of the driving dynamics, i.e., values indicative of pressure, is present is the comparative value determined by use of said values. In one simple embodiment of the method, a field of determined values indicative of the driving dynamics may be stored as an intermediate value.

The storage of the intermediate value may be tied to various predefinable storage trigger conditions, and is regularly performed at predefinable time intervals; the elapsing of a time interval is specified as a storage trigger condition.

One alternative or additional storage trigger condition is the actuation of the ignition lock, in particular shutting off the engine.

A further alternative or additional storage trigger condition is the determination of a value indicative of the driving dynamics. The value may be a value indicative of pressure, an intermediate value which differs by a predefinable amount from an intermediate value, a value indicative of the driving dynamics, or a value indicative of pressure determined at an earlier time.

As a value indicative of the driving dynamics, in particular a value indicative of pressure, a parameter that is indicative of the wheel speed or the tire pressure may be used.

In one embodiment of the method according to the invention, the comparative value and the intermediate value are associated with a predefinable speed range. The vehicle-specific or tire-specific speed band, for example 0-250 km/h, may be divided into multiple ranges such as 0-50 km/h, 50-80 km/h, 80-120 km/h, 120-180 km/h, and 180-250 km/hr. To each of these ranges a comparative value is associated which must be learned for a new vehicle, a new tire, a replaced tire, or because of changes on or in the tire or the surroundings. Comparative values already present are replaced by a newly determined comparative value. An intermediate value is assigned to a speed range or a comparative value and, after conclusion of the learning phase for this intermediate value, preferably can be directly stored as the comparative value, or can be further processed to produce a comparative value and stored.

As with the association with a speed range, further associations of the comparative value or of the intermediate value may alternatively or additionally be made with the vehicle yaw rate, transverse or longitudinal acceleration of the vehicle, wheel vibrations, axle vibrations, vehicle level, spring excursion, or other parameters describing the vehicle dynamics. The vehicle-specific or component-specific value band, for example, 0-1.0 g for transverse acceleration, may be divided into multiple ranges, such as 0-0.1 g, 0.1-0.3 g, 0.3-0.5 g, and 0.5-1.0 g. To each of these ranges a comparative value is assigned which must be learned for a new vehicle or because of changes to the vehicle or the surroundings, such as a replaced tire, mounted spoiler, or modified chassis. Comparative values already present are replaced by a newly determined comparative value. An intermediate value is assigned to a transverse acceleration range or a comparative value and, after conclusion of the learning phase for this intermediate value, preferably can be directly stored as a comparative value, or can be further processed to produce a comparative value and stored.

To determine the comparative value or intermediate value associated with a speed range, yaw rate range, transverse or longitudinal acceleration range, wheel vibration range, axle vibration range, vehicle level range, spring excursion range, or other vehicle dynamics parameter range, in a further embodiment of the method a comparative value associated with another speed range, yaw rate range, transverse or longitudinal acceleration range, wheel vibration range, axle vibration range, vehicle level range, spring excursion range, or other vehicle dynamics parameter range may be used. For example, as a comparative value for the 180-250 km/h speed range, the comparative value for the 120-180 km/h range is used until sufficient values indicative of the pressure are present from the range for the higher speeds in order to generate a comparative value therefrom. A comparative value used from a speed range that is adjacent to a first speed range may also be provided with a correction factor so that it can then be used as a comparative value for the first speed range.

The use of a comparative value from an adjacent range, in particular an adjacent speed range, makes it possible to perform early monitoring of a chassis anomaly or tire pressure, even in ranges, in particular speed ranges, for which few values indicative of driving dynamics or values indicative of pressure are thus far present.

To determine the comparative value or intermediate value associated with a speed range, yaw rate range, transverse or longitudinal acceleration range, wheel vibration range, axle vibration range, vehicle level range, spring excursion range, or other vehicle dynamics parameter range, the comparative values are used which are associated with the two adjacent value ranges for the same parameter. In a simple case, the average of the two adjacent comparative values is stored as the new comparative value for the value range located between the two other ranges.

In a further embodiment of the method according to the invention, the learning threshold for a comparative value is specified as a function of the speed range, yaw rate range, transverse or longitudinal acceleration range, wheel vibration range, axle vibration range, vehicle level range, spring excursion range, or other vehicle dynamics parameter range associated with the comparative value. As the values in a range increase, the predefinable number of values indicative of the driving dynamics, in particular, values indicative of pressure, becomes smaller and is specified as the basis for determining the comparative value as a criterion for reaching the learning threshold.

### BRIEF DESCRIPTION OF THE DRAWING FIGURE

FIG. 1 shows a flow diagram of one advantageous embodiment of the method according to the invention.

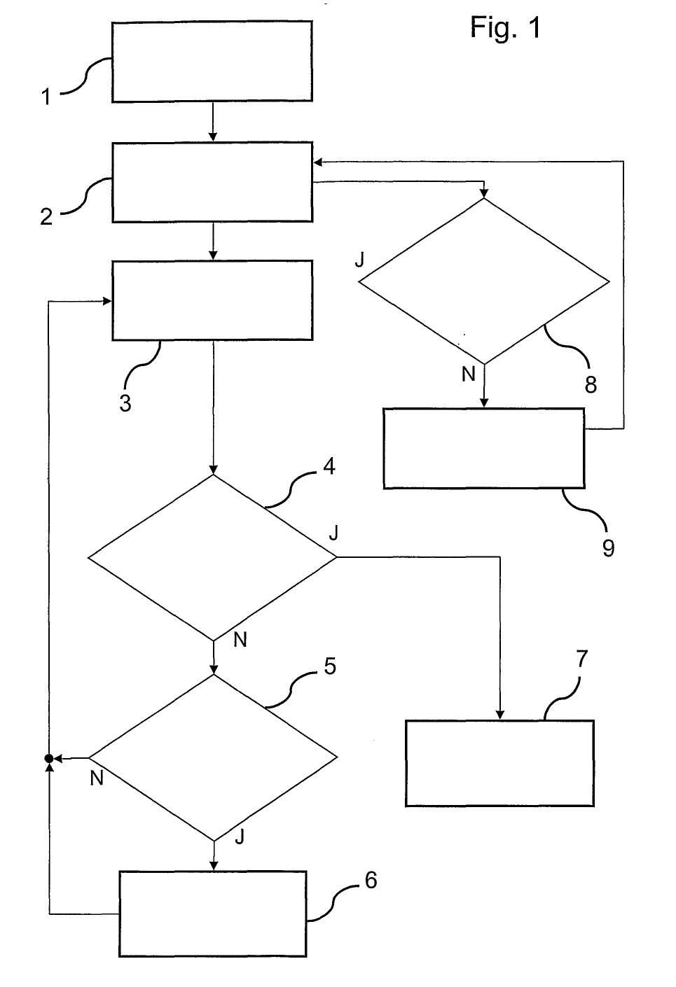

### DETAILED DESCRIPTION OF THE ILLUSTRATED EMBODIMENT

The method for recognizing loss of pressure in a motor vehicle tire begins in step 1 with the detection of the wheel speed for at least one wheel, preferably detection of the wheel speeds for all wheels on the motor vehicle. In step 2 a pressure-indicative value that is indicative of a tire pressure is determined, using the detected wheel speed or wheel speeds. For an automobile, the pressure-indicative value may be determined, for example, by dividing the sum of the wheel speeds for two wheels, such as the left front and right rear wheels, by the sum of the wheel speeds for the other two wheels, such as the right front and left rear wheels. However, other methods and computation operations are possible for determining a pressure-indicative value.

In steps 3 through 7 a comparative value is determined, using the determined pressure-indicative value, the wheel speeds, or wheel rotational frequencies, and is stored. For this purpose, first an intermediate value is determined in step 3 which can be determined, for example, using the same computation rule as for the comparative value.

The difference between the intermediate value and the comparative value is that, for example, for the comparative value a minimum requirement is placed on the number of base values to be used, such as pressure-indicative values, for example. Other examples of requirements for the comparative value may be a predefinable maximum value for a fluctuation over time, or a maximum value for the standard deviation of the underlying base values, or the position of an amplitude of the natural frequency spectrum. One or more such requirements are specified as the learning threshold and are checked in step 4.

If the requirement specified in step 4 is not met, the intermediate value is further processed. In step 5 a check is made as to whether a criterion which can be specified for storing the intermediate value has been met. If this is not the case, a branch is made back to step 3, in which a new intermediate value is determined by using one or more new pressure-indicative values.

If the criterion queried in step 5 is met, a branch is made to step 6 and the intermediate value is stored. Then a branch is likewise made back to step 3 and a new intermediate value is determined.

As the criterion in step 5, it may be specified, for example, that a time period has elapsed, a counter has reached a predefinable level, an ignition lock actuation has taken place, or the engine has been shut off. If, for example, the engine has been shut off, the intermediate value is stored in step 6. Thus, the next time the engine is started the method need not go through a complete cycle for determining a comparative value, and the comparative value is obtained much more quickly starting from the stored intermediate value.

If it is determined in step 4 that the learning threshold has been reached, a branch is made to step 7 and the comparative value is stored, or a comparative value that may already be present is replaced.

Proceeding from step 2, in addition to the branching to step 3, a branch is also made to step 8 in which a pressure comparison takes place by, for example, comparing an instantaneous pressure-indicative value with a comparative value. If this comparison shows that a pressure loss has occurred, a branch is made to step 9 and a warning signal concerning the recognized pressure loss is issued. If the result from step 8 indicates that no pressure loss has occurred, a branch is made back to step 2.

In the determination of the pressure-indicative values, intermediate values, and comparative values, and in particular in steps 2 and 8, additional parameters such as vehicle speed, longitudinal and transverse accelerations, tire temperature, or external temperature may be used. In particular, the pressure-indicative values are compensated for temperature.

The branching to step 8 may also follow from step 1 or from another step.

To determine an intermediate value in step 3 associated with a speed range, previously determined intermediate values associated with other speed ranges or, preferably, a previously determined comparative value associated with an adjacent speed range may be used. The average of the comparative values associated with the adjacent ranges, for example, in particular is used as the intermediate value.

As an alternative to storing as an intermediate value, the values determined in this manner may also be stored directly as a comparative value if the learning threshold for the associated speed range has not been reached.

As an alternative or addition to a speed range, the intermediate value determined in step 3 may also be associated with another vehicle dynamics parameter range such as a yaw rate range, transverse or longitudinal acceleration range, wheel vibration frequency range, axle vibration frequency range, axle or wheel vibration amplitude range, vehicle level range, or spring excursion range.

The embodiment of the method according to the invention illustrated with reference to the figure may, of course, also be used for recognizing other chassis anomalies such as tire sidewall damage, rupture of the tire carcass, separation of tire tread blocks, tire or wheel imbalance, wheel rim deformation, wheel rim rupture, wheel bearing damage, axle damage, axle bearing damage, shock absorber damage, or other chassis anomalies.

Wheel speed information or vibration information is preferably used as the pressure-indicative value for determining an incorrect tire pressure, or for determining the pressure-indicative value. The vibration information may be airborne noise that is detected, such as roll noise of a wheel, or detected structure-borne noise such as vibrations of the tire, wheel, or wheel suspension, a wheel or axle control arm, the axle, or another component induced to vibrate by the wheel. The vibration information may be evaluated by known methods such as natural frequency analysis, for example.

For determining the chassis-indicative value, instead of the wheel speed, other variables indicative of the driving dynamics may also be used, such as the vehicle yaw rate, transverse or longitudinal acceleration of the vehicle, wheel vibrations, axle vibrations, vehicle level, or spring excursion. Of course, a plurality of these variables may also be used for determining the chassis-indicative value.

1-12. (canceled)

13. A method for recognizing a chassis anomaly comprising:
determining an instantaneous chassis-indicative value that is indicative of a chassis anomaly,
determining an intermediate value,
determining whether a predefinable learning threshold for storing a comparative value has been reached,
determining whether at least one storage triggering condition is met,
storing the intermediate value when the predefinable learning threshold for storing the comparative value has not been reached and the storage triggering condition is met,
storing the intermediate value as the comparative value when the predefinable learning threshold has been reached, and
comparing the instantaneous chassis-indicative value with the comparative value to recognize a chassis anomaly.

14. The method according to claim 13, wherein the learning threshold is specified by requiring that a predefinable minimum number of determined chassis-indicative values must have been used for determining the comparative value.

15. The method according to claim 13, wherein actuation of an ignition lock is specified as a storage triggering condition.

16. The method according to claim 13, wherein elapsing of a time interval is specified as a storage triggering condition.

17. The method according to claim 13, wherein a presence of an intermediate value which differs by a predefinable amount from an intermediate value determined at an earlier time is specified as a storage triggering condition.

18. The method according to claim 13, wherein the comparative value and the intermediate value are associated with a predefinable vehicle dynamics parameter range.

19. The method according to claim 13, wherein, for determining a comparative value or an intermediate value associated with a vehicle dynamics parameter range, a comparative value associated with another vehicle dynamics parameter range is used.

20. The method according to claim 19, wherein, for determining the comparative value or intermediate value associated with the vehicle dynamics parameter range, comparative values associated with adjacent vehicle dynamics parameter ranges are used.

21. The method according to claim 18, wherein the learning threshold is specified as a function of the vehicle dynamics parameter range.

22. The method according to claim 21, wherein, as a learning threshold for a higher-value vehicle dynamics parameter range, a lesser number of pressure-indicative values is required than for a lower-value vehicle dynamics parameter range.

23. The method according to claim 18, wherein the vehicle dynamics parameter range is a speed range.

24. The method according to claim 13, wherein the chassis anomaly is a loss of tire pressure in a motor vehicle tire, and wherein the chassis-indicative value is a pressure-indicative value that is indicative of a tire pressure.

25. The method according to claim 15, wherein said actuation provides for shutting off of an engine.

26. The method according to claim 14, wherein the chassis anomaly is a loss of tire pressure in a motor vehicle tire, and wherein the chassis-indicative value is a pressure-indicative value that is indicative of a tire pressure.

27. The method according to claim 15, wherein the chassis anomaly is a loss of tire pressure in a motor vehicle tire, and wherein the chassis-indicative value is a pressure-indicative value that is indicative of a tire pressure.

28. The method according to claim 16, wherein the chassis anomaly is a loss of tire pressure in a motor vehicle tire, and wherein the chassis-indicative value is a pressure-indicative value that is indicative of a tire pressure.

29. The method according to claim 17, wherein the chassis anomaly is a loss of tire pressure in a motor vehicle tire, and wherein the chassis-indicative value is a pressure-indicative value that is indicative of a tire pressure.

30. The method according to claim 18, wherein the chassis anomaly is a loss of tire pressure in a motor vehicle tire, and wherein the chassis-indicative value is a pressure-indicative value that is indicative of a tire pressure.

31. The method according to claim 19, wherein the chassis anomaly is a loss of tire pressure in a motor vehicle tire, and wherein the chassis-indicative value is a pressure-indicative value that is indicative of a tire pressure.

32. The method according to claim 20, wherein the chassis anomaly is a loss of tire pressure in a motor vehicle tire, and wherein the chassis-indicative value is a pressure-indicative value that is indicative of a tire pressure.
